(19) United States
(12) Patent Application Publication
(10) Pub. No.: US 2015/0248159 A1
(43) Pub. Date: Sep. 3, 2015

(54) PIEZORESISTIVE SENSORS AND METHODS

(71) Applicant: Florida State University Research Foundation, Inc., Tallahassee, FL (US)

(72) Inventors: Sida Luo, Tallahassee, FL (US); Tao Liu, Tallahassee, FL (US)

(21) Appl. No.: 14/309,383

(22) Filed: Jun. 19, 2014

Related U.S. Application Data
(60) Provisional application No. 61/837,009, filed on Jun. 19, 2013.

(51) Int. Cl. G06F 3/01; B05D 3/00; B05D 7/20; B05D 1/02; G01D 5/12; G01L 1/18

(52) U.S. Cl. CPC G06F 3/014; G01D 5/12; G01L 1/18; G06F 3/011; B05D 7/20; B05D 1/02; B05D 3/007

(57) ABSTRACT

Piezoresistive sensors are provided that include a flexible substrate, a flexible thin film coating on the flexible substrate and two or more electrodes connected to the thin film coating at spaced locations of the thin film coating, wherein the thin film coating includes carbon nanotubes, graphite nanoplatelets, or a combination of carbon nanotubes and graphite nanoplatelets. The thin film coating can be a hybrid thin film including carbon nanotubes and graphite nanoplatelets. The flexible substrate can be in a form configured to provide conformal contact with a wearer of the sensor so that body movements of the wearer at or about the flexible substrate effect reversible changes in a piezoresistive signal through the two or more electrodes. Methods are provided for a user to interact with a remote device using the piezoresistive sensors. Methods also are provided for making conductive coated fibers for use in embodiments of the piezoresistive sensors.

### CROSS-REFERENCE TO RELATED APPLICATIONS

This application claims priority to U.S. Provisional Application No. 61/837,009, filed Jun. 19, 2013, which is incorporated herein by reference.

### GOVERNMENT SUPPORT

This invention was made with government support awarded by the Air Force Office of Scientific Research under grant number FA9550-11-1-0084. The U.S. Government has certain rights in the invention.

### FIELD

This disclosure is generally in the field of sensors and sensor systems, and more particularly peizoresistive sensors, which, for example, may be capable of facilitating human-machine interaction.

### BACKGROUND

Human-machine interfaces provide ways to give commands to control computing systems or other programmable systems, for example robotic systems. However, current human-machine interface technologies face certain limitations when in use. For example, a touch sensing device, e.g., the Microsoft Surface™ tablet, requires the user's hand to be occupied. Optical sensing devices, e.g., the Celluon Magic Cube™ and the Xbox Kinect™ have a built-in optical sensor to capture finger and/or body movements, but these devices still have a limited space for a user to send commands to the machine. As another example, the voice control in smart phones, e.g., Apple iPhone® 5, is also limited by its accuracy, time delay, and a singular method of interaction.

Challenges associated with the development of human-machine interaction interfaces include the limitations of traditional interactions, such as holding and clicking of a wired or wireless keyboard or input device, touch sensing, optical sensing, and voice sensing. One challenge is developing systems that integrate these interactions into a seamless human-machine interface that does not limit interaction interfaces to a single traditional interaction.

It therefore would be desirable to provide new sensor systems to enable human-machine interactions that ameliorate one or more of these limitations.

One type of sensor which may have use in such human-machine interactions is a piezoresistive sensor. Conventional piezoresistive sensors, however, rely on metal or semiconductor piezoresistive materials, which yield suboptimal sensitivities. For example, metal foil-based strain gauges are known, but their relatively low sensitivities, as measured by their gauge factor (GF), limits their usefulness in human-machine interactions. It therefore would be desirable to provide piezoresistive sensors having greater sensitivities, e.g., higher gauge factors, than those typical of traditional metal and semiconductor piezoresistive sensors.

### BRIEF SUMMARY

In one aspect, a piezoresistive sensor is provided which includes a flexible substrate, a flexible thin film coating on the flexible substrate, and two or more electrodes, wherein the flexible thin film coating comprises carbon nanotubes, graphite nanoplatelets, or a combination (e.g., a hybrid) of carbon nanotubes and graphite nanoplatelets. The two or more electrodes are connected to the thin film coating at spaced locations of the thin film coating, and the flexible substrate may be in a form that is configured to provide conformal contact with a wearer of the sensor, so that body movements of the wearer at about the flexible substrate effect reversible changes in a piezoresistive signal through the two or more electrodes.

In another aspect, a method is provided for a user to interact with a remote device. The method includes providing the user with at least one piezoresistive sensor and transmitting to the remote device a signal produced with the at least one sensor, wherein the piezoresistive sensor includes a flexible substrate, a flexible thin film coating on the flexible substrate, and two or more electrodes connected to the thin film coating. The flexible thin film coating includes carbon nanotubes, graphite nanoplatelets, or a combination of carbon nanotubes and graphite nanoplatelets.

In still another aspect, a continuous method is provided for making conductive coated fibers for use in piezoresistive sensors. The method includes unspooling a continuous strand of a fiber from a first roll of the fiber and spray coating onto the continuous strand of fiber a suspension in a liquid non-solvent; removing the non-solvent from the continuous strand to form a flexible thin film coating on the strand of fiber; and spooling the coated continuous strand onto a second roll, wherein the coating is composed of carbon nanotubes, graphite nanoplatelets, or a combination of carbon nanotubes and graphite nanoplatelets.

### BRIEF DESCRIPTION OF THE DRAWINGS

FIG. 1A is a cross-sectional view of a piezoresistive sensor in a first position in accordance with an embodiment of the present disclosure.

FIG. 1B is a cross-sectional view of the piezoresistive sensor in FIG. 1 in a second position in accordance with an embodiment of the present disclosure.

FIG. 2A is a plan view of a piezoresistive sensor in accordance with an embodiment of the present disclosure.

FIG. 2B is perspective view of the piezoresistive sensor shown in FIG. 2A being worn on a user's finger in accordance with an embodiment of the present disclosure.

FIG. 3 is a graph showing change in measured resistance as a user (wearer) of the piezoresistive sensor shown in FIG. 2B flexes his or her finger in different positions, thereby altering the conformational position of the sensor, in accordance with an embodiment of the present disclosure.

FIG. 4 is another graph showing the measured resistance as a user (wearer) of the piezoresistive sensor shown in FIG. 2B flexes his or her finger into different positions, thereby altering the conformational position of the sensor and giving a reproducible signal at each position, in accordance with an embodiment of the present disclosure.

FIG. 5A is a perspective view of a conductive fiber for use in a piezoresistive sensor in accordance with an embodiment of the present disclosure.

FIG. 5B is a cross-sectional view of the conductive fiber shown in FIG. 5A.

FIG. 5C is perspective views of two example configurations for a plurality of the conductive fibers of FIGS. 5A-5B.

FIG. 6 is a schematic diagram of a method for making a conductive coated fiber in a continuous process, wherein the conductive coated fiber is one which may be used in a piezoresistive sensor in accordance with an embodiment of the present disclosure.

FIGS. 7A-7C are scanning electron micrographs (SEMs) of an uncoated fiber at 1 μm (FIG. 7A), a coated conductive fiber at a 10 μm scale (FIG. 7B), and a coated conductive fiber at a 1 μm scale (FIG. 7C).

FIG. 8 is a graph showing electrical resistance and strain (coupled electrical-cyclic tensile strength) measured for a conductive coated fiber in accordance with one embodiment of the present disclosure.

FIG. 9 is a schematic diagram of a piezoresistive sensor interfacing with a personal computer in accordance with an embodiment of the present disclosure.

### DETAILED DESCRIPTION

Piezoresistive sensors have been developed that include a flexible thin film coating which includes carbon nanotubes (CNTs), graphite nanoplatelets (GNPs), or a combination of CNTs and GNPs. These piezoresistive sensors have a higher sensitivity compared to conventional piezoresistive sensors, e.g., a metal foil based strain gauge. In addition, the piezoresistive as described herein include a flexible substrate on which the flexible thin film coating of CNTs and/or GNPs is coated, thereby advantageously providing a piezoresistive sensor that is both capable of being worn by a user and that accurately/reproducibly responds to body movements of the user. These features of the sensors beneficially enable the user to interface, wirelessly or wired, with electronic devices in new ways, which may mitigate traditional interface limitations.

In embodiments, the piezoresistive sensors are generally flexible. As used herein, the term “flexible” itself or when used to modify or describe the sensor and/or components thereof means capable of elastically bending or twisting under loads generated by body movements of the wearer of the sensor when generally in conformal contact with the wearer.

In one embodiment, the piezoresistive sensor includes a flexible substrate; a flexible thin film coating disposed onto the flexible substrate, wherein the thin film coating includes CNTs, GNPs, or a combination of CNTs and GNPs; and two or more electrodes connected to the flexible thin film coating. An operating system for the sensor may further include a power source, a controller, and/or other components for directing power to and/or receiving signals from the piezoresistive sensor.

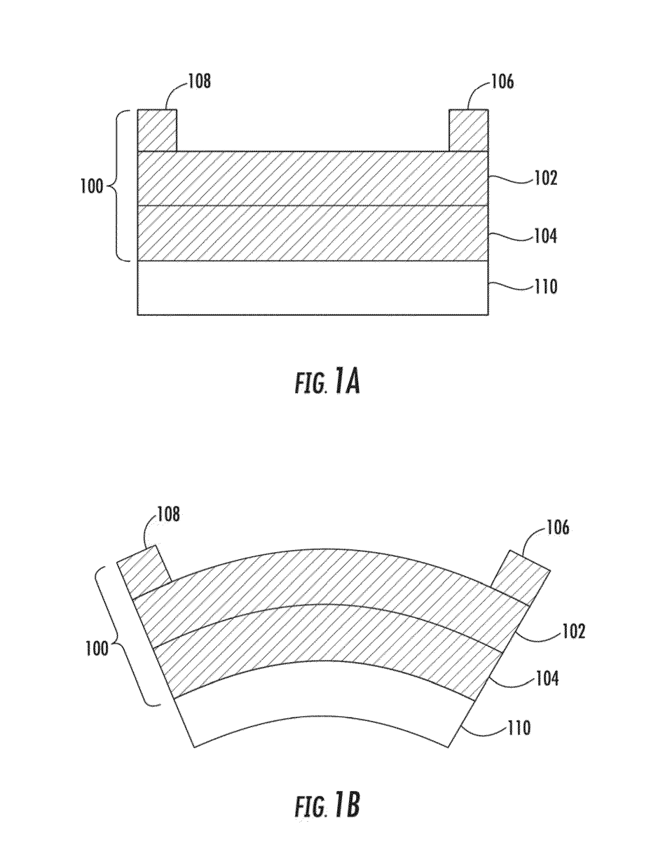

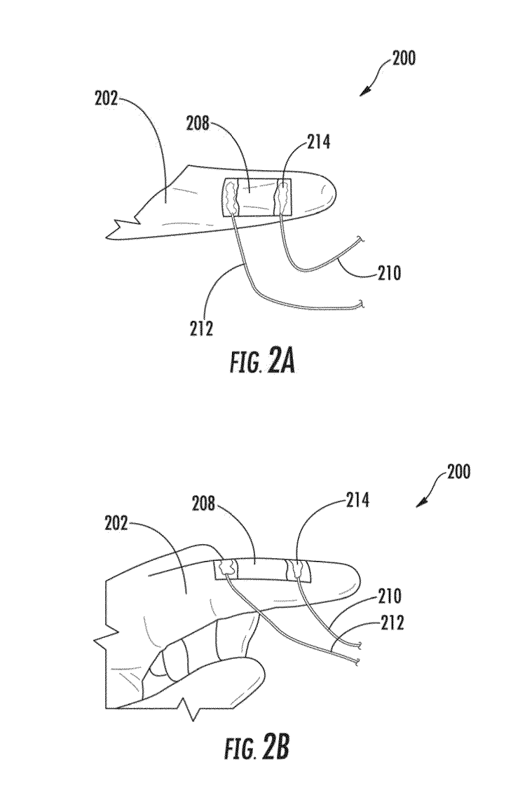

FIGS. 1A and 1B illustrate a piezoresistive sensor 100 conformingly positioned against a wearer surface 110. The sensor 100 includes a flexible thin film coating 102 which is coated onto a flexible substrate 104. The sensor 100 also includes a pair of electrodes 106, 108 that are electrically connected to the flexible thin film coating 102 at spaced locations on the flexible thin film coating 102. The phrase “spaced locations” refers to locations discrete from one another and in electrical contact with the film coating to permit electric current flow from one of the electrodes through the flexible thin film coating and to a second electrode, wherein the electrodes are positioned from one another a distance effective to cause a variation in measured resistance as the thin film coating is elastically deformed.

FIG. 1A shows the sensor 100 in a straight, unflexed configuration, and FIG. 1B shows the sensor 100 in a curved, flexed configuration, which has been caused by a change in shape/position of the wearer surface 110, which may for example be a bending or flexing of part of a wearer's body. In embodiments, the wearer surface 110 may be the skin of the wearer about his or her finger, hand, arm, leg, foot, face, torso, etc. In FIGS. 1A-1B, the piezoresistive sensor 100 is conformally positioned to a wearer surface 110 so that the body movements of the wearer at or about the sensor 100 are transferred as a mechanical force to elastically deform the flexible substrate 104 and the thin film coating 102. This deformation results in a change in electrical resistivity of the flexible thin film coating 102, thereby effecting a change in the voltage differential between the electrodes 106, 108 and thus producing a reversible change in a piezoresistive signal from the sensor 100.

### Flexible Substrate

The flexible substrate supports the flexible thin film coating, and optionally may support additional elements of a sensor system. In embodiments, the flexible substrate is substantially non-electrically conductive. The flexible substrate may be made of any suitable material that allows the piezoresistive sensor to function as described above. In one embodiment, the flexible substrate is an elastic material in any form configured to provide conformal contact with a wearer of the sensor. In an embodiment, the flexible substrate includes a polymer. In embodiments, the flexible substrate comprises latex, polyurethane, silicone, or another elastomeric material.

The flexible substrate can be provided in a number of different forms. In one embodiment, the flexible substrate is in the form of a sheet, such as a monolithic sheet. In another embodiment, the flexible substrate comprises one or a plurality of fibers, which may be woven, unwoven, bundled, or networked. The flexible substrate may have fibers each of which are individually coated with the thin film coating of CNTs and/or GNPs, or the flexible substrate may have fibers which are only coated in part with the thin film coating of CNTs and/or GNPs, which coating forms a continuous conductive path between the electrodes.

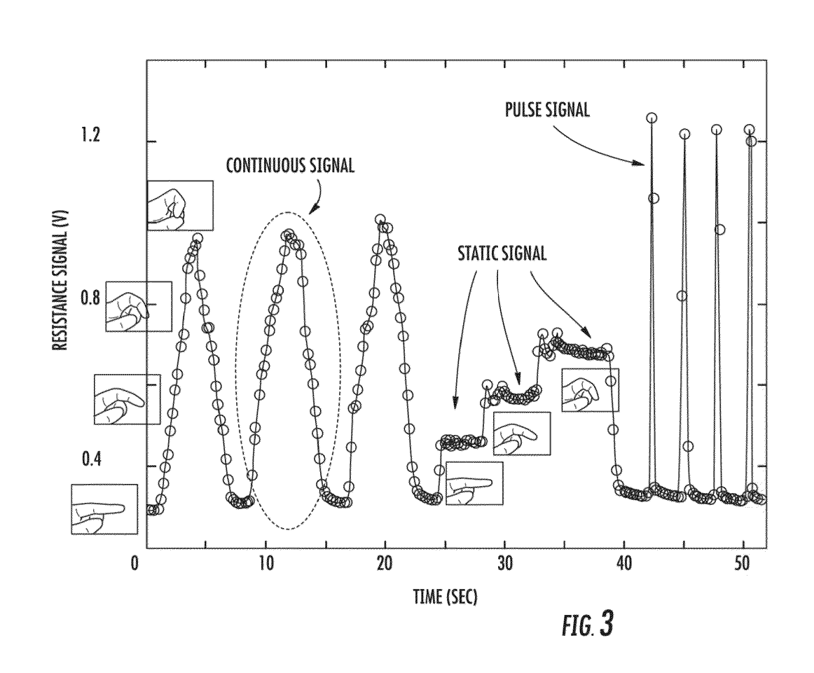

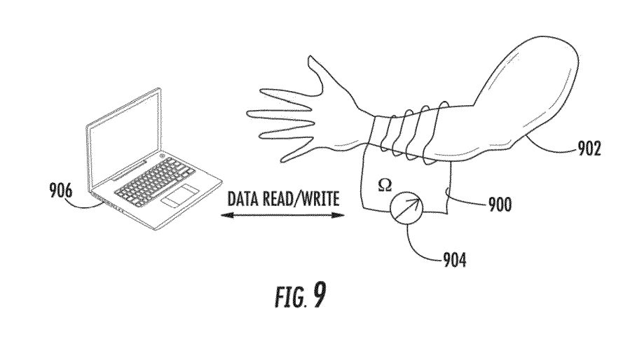

In one embodiment, the flexible substrate is in a form configured to be worn by, or removably attachable, to a user. In a preferred embodiment, the flexible substrate is configured to conformingly fit against one or more portions of the user's body. The user may be a human or animal. In non-limiting embodiments, the flexible substrate is attached to or integral with a glove, sock, mask, or other article of clothing. For example, FIGS. 2A-2B illustrate a flexible substrate that is part of the finger portion of a glove. As another example, FIG. 9 shows how a fiber-type flexible substrate can be wrapped around a user's arm. One can envision incorporating such a flexible substrate into the sleeve of a shirt or long glove.

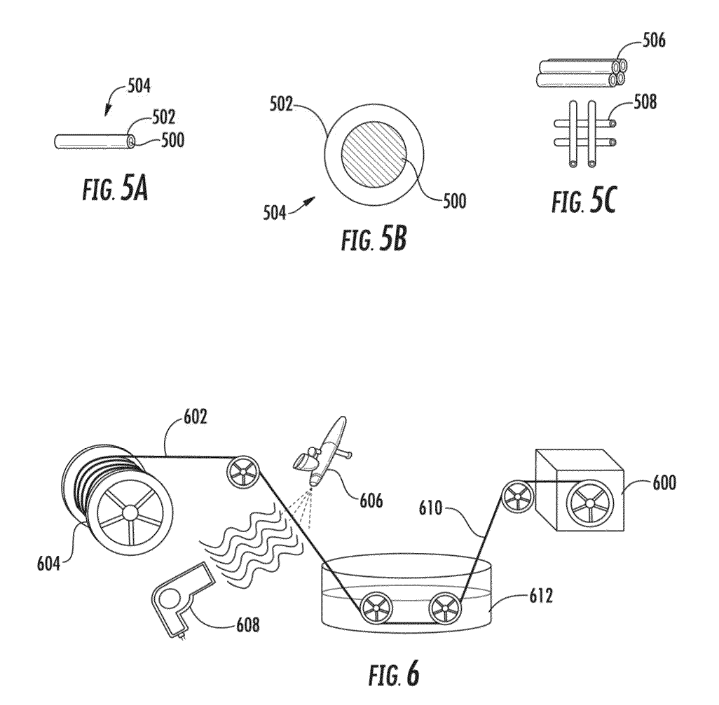

A fiber-based flexible substrate can take a number of different forms. For example, FIGS. 5A-5B shows conductive coated fiber 504 which comprises flexible fiber substrate 500 on which a flexible thin film 502 of CNTs and/or GNPs is coated. FIG. 5C illustrates two of the possible arrangements or structures of the coated fibers: a bundled form 506 and a networked form 508.

The fiber substrate can be made from various materials of construction. In embodiments, the fibers are substantially non-electrically conductive. Non-limiting examples include glasses as well as aramids and other polymers. The fibers may be natural or synthetic. Examples of natural fibers include cotton, hemp, and silk. Examples of synthetic fibers include polyurethanes, nylons, and polyesters. The fiber substrate may itself be a composite of two or more different materials.

### Flexible Thin Film Coating

The flexible thin film coating comprises carbon nanotubes (CNTs), graphite nanoplatelets (GNPs), or a combination thereof.

Non-limiting examples of suitable types of CNTs may include multi-walled carbon nanotubes (MWCNTs), few-walled carbon nanotubes (FWCNTs), single-walled carbon nanotubes (SWCNTs), or any combination thereof. In a preferred embodiment, the CNTs include HiPCO® SWCNTs (Unidym™, single walled carbon nanotubes). In certain embodiments, the dimensions of the CNTs may be from about 0.3 μm to about 10 μm in length and from about 0.5 nm to about 10 nm in diameter.

Suitable GNPs may be produced by different methods, including but not limited to, chemical vapor deposition (CVD), physical vapor deposition (PVD), and colloidal dispersion. In a preferred embodiment, GNPs are produced using the colloidal dispersion method. In certain embodiments, the GNPs may be from about 1 μm to about 10 μm in lateral dimension and from about 1 nm to about 50 nm in thickness.

CNTs have been demonstrated to possess a high degree of piezoresistive sensitivity. The gauge factor (GF) of an individual CNT—a measure of the sensitivity of the sensor—is reported to be in the range of about 400 to about 1000², which is higher than the typical sensitivity of traditional metal and semiconductor piezoresistive sensors. However, in comparison to an individual CNT, the GF of a CNT based thin film differs. For example, in “Structure-property-processing relationships of single-wall carbon nanotube thin film piezoresistive sensors,” by Sida Luo et al., Carbon, Vol. 59 (2013), pp. 315-324, it was reported that the GF of SWCNT thin film piezoresistive sensors was found to be inversely proportional to the excluded volume of SWCNT bundles.

Regarding the sensitivity of GNPs, the GF of a GNP thin film has shown a strong dependence on the sheet resistance of the thin film. For example, in “SWCNT/Graphite Nanoplatelet Hybrid Thin Films for Self-Temperature-Compensated, Highly Sensitive, and Extensible Piezoresistive Sensors,” by Sida Luo et al., Advanced Materials, Vol. 25 (2013), pp. 5650-5657, it was reported that when sheet resistance ranges from about 1 KΩ/sq to about 10 MΩ/sq, the GF is increased from about 5 to about 30. This demonstrates that the higher the sheet resistance of a GNP film, the higher the GF.

In some embodiments, the flexible thin film coating is a CNT or GNP thin film. A CNT thin film may be formed by an assembly of many individual CNTs. A GNP thin film may be formed by an assembly of many individual GNPs.

In a preferred embodiment, the flexible thin film coating is a hybrid thin film comprising CNTs and GNPs. The CNT/GNP hybrid thin film may have a GF that is in the range of about 5 times greater to about 30 times greater, about 5 times greater to about 20 times greater, or about 5 times greater to about 10 times greater than the GF of a comparable neat CNT thin film. In comparison to a neat GNP thin film, the GF of a CNT/GNP hybrid film is accordingly decreased, indicating that the greater the amount of SWCNTs within the CNT/GNP hybrid film, the less sensitive the piezoresistive response. The CNT/GNP hybrid thin film may be formed by an assembly of many individual CNTs and GNPs. Varying the ratios of CNTs and GNPs in the flexible thin film coating may determine the GF for the hybrid thin film. Thus, depending upon the target applications and the required sensing characteristics, the mass ratio of SWCNT to GNP in the SWCNT/GNP hybrid film may differ.

In certain embodiments, the flexible thin film coating has a thickness on the substrate from about 50 nanometers to about 500 nanometers.

### Electrodes

The sensor includes electrodes to facilitate passage of electric current through the thin film, which comprises CNTs, GNPs, or a combination thereof. The two or more electrodes are made of suitable conductive materials. Non-limiting examples include metallic materials such as copper, aluminum, silver, gold or chromium, or alloys of these or other metals. In embodiments, the electrodes provide high electrical conductivity and a mechanical strength effective for maintaining electrical coupling with the flexible thin film coating.

The two or more electrodes are connected to the flexible thin film coating at spaced locations on/in the flexible thin film coating. They may be attached using essentially any means known in the art, including soldering, welding, adhesives, eutectic bonding, friction/sonic bonding, mechanical clamps, etc. In one embodiment, the electrodes are adhered to the flexible thin film coating by applying and drying a silver paste and epoxy resin. The two or more electrodes also are connected to components useful for operating the peizoresistive sensor. For example, the electrodes may be connected to electrical leads that in turn connect to power sources, controllers, antennae, and/or other components needed to measure and transmit (e.g., wirelessly or wired) signals corresponding to the measured changes in electrical resistance through the conductive flexible thin films of the sensors.

### Making the Sensors

In embodiments, the sensors are made by producing a suitable thin film of the CNTs and/or GNPs fixed onto a suitable flexible substrate, and then providing electrical connections to the thin film on the substrate. In one embodiment, CNTs and/or GNPs are dispersed/suspended in a continuous fluid phase (e.g., a non-solvent liquid) and then this dispersion or suspension is applied onto the substrate by suitable techniques. Drying to remove the continuous fluid phase yields the thin film structure. The non-solvent liquid may include or consist of water, and optionally may further include one or more surfactants or other additives to facilitate the process.

In one embodiment, the method for producing the piezoresistive sensor structures includes (1) preparing a coating composition that includes a dispersion (or suspension) comprising CNTs and/or GNPs; (2) applying the coating composition onto a flexible substrate; (3) drying the applied coating composition to form a flexible thin film coating which comprises CNTs and/or GNPs; and (4) attaching two or more electrodes to the flexible thin film coating. The coating composition may be applied by spray coating, curtain coating, or other suitable coating techniques known in the art. In certain embodiments, the coating composition may be applied as two or more dispersions in series in any order. In other embodiments, the coating composition may be applied as a single dispersion comprising a mixture of a CNT dispersion and a GNP dispersion.

In one embodiment, a coating composition is prepared as a CNT or GNP dispersion by sonicating a mixture of the CNT and/or GNP raw materials (e.g., single walled carbon nanotubes and/or graphite) with a surfactant in deionized water. In a particular embodiment, the surfactant is sodium dodecylbenzene sulfonate. In other embodiments, different surfactants are used.

The applied coating composition may be dried at any suitable temperature using any suitable process. For example the applied coating composition can be dried at ambient temperatures and humidity, or it may be dried with the aid of an oven or a system for flowing hot and/or dry air or inert gases across the film.

It may furthermore be desirable to remove some or all of the surfactant from thin film coating after the coating composition has been dried. For example, the dried coating composition can be treated with a solvent for the surfactant, such as by washing or passing the dried coating composition through a bath of a solvent for the surfactant which does not significantly affect the CNT/GNP film.

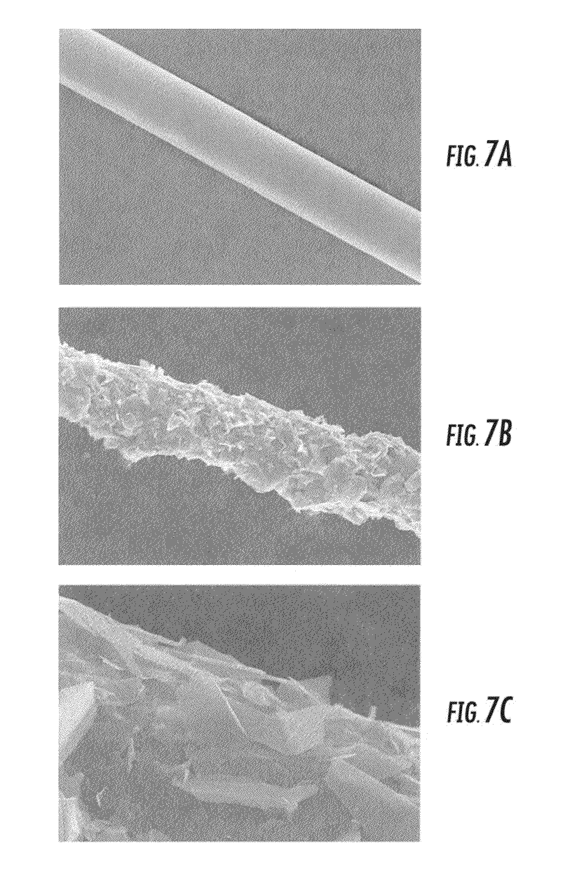

In instances where the flexible substrate is in the form of a fiber, a variety of processes may be used to apply the coating composition to the fiber substrate. In a preferred embodiment, the coating composition is applied in a continuous process that includes spray coating. In one embodiment, the continuous process includes spray coating in combination with a roll-to-roll fiber unwinding/winding process. One example of this process is illustrated in FIG. 6.

For example, the method may include: (1) unspooling a continuous strand of a fiber from a first roll of the fiber; (2) spray coating onto the continuous strand of fiber a suspension that comprises carbon nanotubes, graphite nanoplatelets, or a combination of carbon nanotubes and graphite nanoplatelets, in a liquid non-solvent; (3) removing the non-solvent from the continuous strand to form a flexible thin film coating on the strand of fiber, wherein the coating comprises carbon nanotubes, graphite nanoplatelets, or a combination of carbon nanotubes and graphite nanoplatelets; and (4) spooling the coated continuous strand onto a second roll. The method may further include, between steps (3) and (4) for example, washing the coated continuous strand, for example to remove surfactant or other substances from the flexible thin film coating. In one embodiment, the washing may be performed by passing the continuous strand through a bath containing water or another solvent for the substance to be removed. The method may further include a drying step after the washing.

In some embodiments, the spray coating may be performed in conjunction with application of heated air to accelerate evaporation of the liquid non-solvent.

FIG. 6 illustrates a process for fabricating a coated conductive fiber in a continuous process. A stepper motor 600 is used to unspool a continuous strand of uncoated fiber 602 from a fiber spool 604 at a suitable speed. A sprayer 606 is used to apply a suspension of the coating composition onto the moving strand of fiber 602, and a heat gun 608 directs hot air onto the coated fiber 610 to accelerate evaporation/removal of the non-liquid solvent from the thin film coating and drying of the coating. The coated fiber 610 is then passed through a bath 612 of deionized water to remove some of all of any residual substances, such as surfactants, that may be present in the coating of the coated fiber 610. The washed coated fiber 610 is then air dried before being wound onto a second spool.

### Operation of the Piezoresistive Sensor

The piezoresistive sensor is generally operated by flow of a DC electrical current through the flexible thin film coating of the CNTs/GNPs, via a pair of electrodes connected to the flexible thin film coating, and measuring a change in voltage change caused by bending, twisting, flexing or other elastic deformations of the flexible thin film coating. In particular embodiments, these elastic deformations include bending, twisting, flexing, or other elastic deformations of the flexible substrate underlying the flexible thin film coating. In the case where the flexible substrate is a fiber, the elastic deformation may include application of a tensile or compression force to the coated fiber, e.g., an axial pulling or pushing of the fiber.

In a preferred embodiment, these elastic deformations correspond to body movements of a person wearing the sensor. For example, the flexible substrate may be in a form configured to provide conformal contact with the wearer of the sensor, so that body movements of the wearer at or about the flexible substrate effect reversible changes in a piezoresistive signal through the two or more electrodes.

These reversible changes may, for example, be observed as voltage increase or decrease from a baseline. In one embodiment, the voltage increases, or decreases, by about 2.0 V, about 1.5 V, about 1.0 V, about 0.5 V, or about 0.2 V when the flexible substrate is deformed from a first position to a second position. In another embodiment, the voltage increases, or decreases, from about 0.5 V to about 2.0 V, about 0.5 V to about 1.5 V, or about 0.5 V to about 1.0 V when the flexible substrate is deformed from a first position to a second position.

In an embodiment, the voltage change is reversible and rapid, which generally is preferred for human-machine interaction applications. These reversible and rapid voltage changes advantageously can be correlated with specific body movements, which can facilitate accurate and robust programming for recognizing the actions/commands delivered by the wearer of the sensor.

The piezoresistive sensor generally is part of a system that includes other electrical components for operation, including but not limited to suitable power sources, data acquisition modules, processors, transmitters/receivers, microcontrollers, and the like. For example, a multiplexer may receive the piezoresistive signal from the piezoresistive sensor and transmit the data through a data acquisition module to a data logging module and further to a processing unit such as a personal computer (PC) or a handheld device. The transmission of data may continue further to a server, either through the PC or handheld device or through a communication module. In various embodiments, one or more parts of the electronic circuitry are located within the piezoresistive sensor itself or may be remotely located.

In one embodiments, for example in FIG. 9, the piezoresistive sensor 900 may be in conformal contact with a user 902 and may include a power source 904 and a transmitter (not shown) for wirelessly transmitting a piezoresistive signal to a remote device, such as a PC 906, a handheld device, or the like, to interact with such remote device. Thus, a user may interact with a remote device by using at least one piezoresistive sensor and wirelessly transmitting to the remote device a piezoresistive signal produced with the at least one piezoresistive sensor.

### Using the Piezoresistive Sensor

The signals from the piezoresistive sensor may be generally classified into three categories according to body movements of the wearer of the sensor: continuous signal, static signal, or pulse signal. See Example 2 below and FIG. 3, wherein a user bends or straightens the gloved finger, producing a voltage signal which is continuous and either increases or decreases. Alternatively, the user may quickly bend and release the gloved finger, producing pulsed signal, or the user may move the gloved finger while the finger maintains a fixed angle, producing a static signal.

One may use these sensor outputs in a wide variety of applications. For instance, the continuous voltage signal can be programmed to adjust sound volume, adjust the zoom on a viewed image, scroll up/down a web page or electronic book, shift the visual angle in a video game, control the movement of a robotic arm, etc. As another example, the pulse signal can be programmed to pause a movie, mute a song, send an email, shut down software, trigger a rifle in a shooting game, initialize a robot, etc. Different values of the static signal can be programmed to e.g., turn a webpage/photo forward or backward, select the next or previous email/song/file, move the cursor to the left or to the right, control a video game character's direction of movement, and drive or reverse a remote control car, etc.

A user who wears the piezoresistive sensor described herein can, for example, make phone calls, write emails, play video games, and adjust music volume using a finger movement or another body movement without having to otherwise touch or manipulate a traditional user interface device. Furthermore, a wireless piezoresistive sensor may be implemented by integrating some or all of the electric circuitry components within the sensor itself or remote therefrom. These sensors and systems have, for example, the potential to remotely control robots that are working in extreme environments, including but not limited to bomb disposal and deep sea exploration. In other embodiments, the piezoresistive sensors may be used to capture the motion of particular regions of the human body to control and/or interact with, for instance, 3-D movies and/or video games. In other embodiments, the piezoresistive sensors may be used to monitor the body conditions of the wearer. For instance, the disclosed the piezoresistive sensor can be used for monitoring the rehabilitation progress of a patient, such as wound healing, breathing conditions such as blood oxygen concentration, and heart rate monitoring. The piezoresistive sensors may also be used to monitor the muscle, breath, and fatigue conditions of an athlete during training and may help to reduce injuries and boost performance.

The piezoresistive sensors and methods may be further understood with the following non-limiting examples.

### EXAMPLE 1

### Preparation of a Wearable Piezoresistive Sensor

A flexible thin film coating was prepared that included CNTs and GNPs. First, dispersions of the components were produced, and then the dispersions were applied onto a finger of a nitrile glove as a flexible substrate, therefore forming the thin film coating on the nitrile substrate.

The coating compositions were prepared as follows. The CNT dispersion was prepared by sonicating a mixture of 16 mg SWCNTs (Unidym™, single walled carbon nanotubes, Lot #PO258), 700 mg sodium dodecylbenzene sulfonate (SDBS, CAS # 25155-30-10, Sigma-Aldrich), and 100 g deionized water in an ice bath using a Misonix 3000 probe sonicator (20 kHz). The sonicator was operated in a pulse operation mode (on for 10 s, off for 30 s) with the power set at 45 W for a total sonication time of 1 hr. The GNP dispersion was similarly prepared by mixing 330 mg graphite (Aldrich, CAS # 7782-42-5), 70 mg SDBS, and 100 g deionized water followed by sonication for 8 hrs. using the same protocol described for the CNTs.

A finger of a nitrile glove (Touch N Tuff®, powder-free disposable nitrile gloves) was cut off and mounted on a hot plate (1000-1 Precision Hot Plate, Electronic Micro Systems). The temperature of the hot plate was set at 90° C. to facilitate liquid non-solvent (water) evaporation when the CNT and GNP dispersions were spray coated in series onto the glove substrate.

The coating composition was applied to the prepared substrate by spray coating, which was carried out with an Iwata Eclipse HP-BS airbrush operated at 200 kPa. The coating area was confined to a rectangular region and produced a 3 cm×1.5 cm GNP/CNT hybrid thin film on the glove finger. Following the spraying process, the coated finger was washed by immersion in deionized water to remove residual SDBS. The washed thin film was dried on a hot plate at 90° C.

Electrodes were then attached to the GNP/CNT hybrid thin film. Two copper wires (0.18 mm in diameter) were attached and fixed to the two ends of the hybrid thin film by applying a silver paste (Electron Microscopy Sciences, silver adhesive 503, Cat # 12686-15). The residual solvent in the silver paste was removed by drying the electrode-attached hybrid thin film glove finger at 70° C. for about 2 hrs. Epon635 thin epoxy resin was mixed with a medium epoxy hardener (US Composites) in a 3:1 ratio and applied to cover the electrodes, and then cured at 90° C. for one hour to obtain an exemplary piezoresistive sensor glove, which is shown in FIGS. 2A and 2B.

In these figures, sensor 200 includes nitrile glove substrate 202 having GNP/CNT hybrid thin film coating 208. Electrodes 210 and 212 are attached to the CNT/GNP hybrid thin film 208 using a combination 214 of silver paste and an epoxy resin.

### EXAMPLE 2

### Performance of a Wearable Piezoresistive Sensor

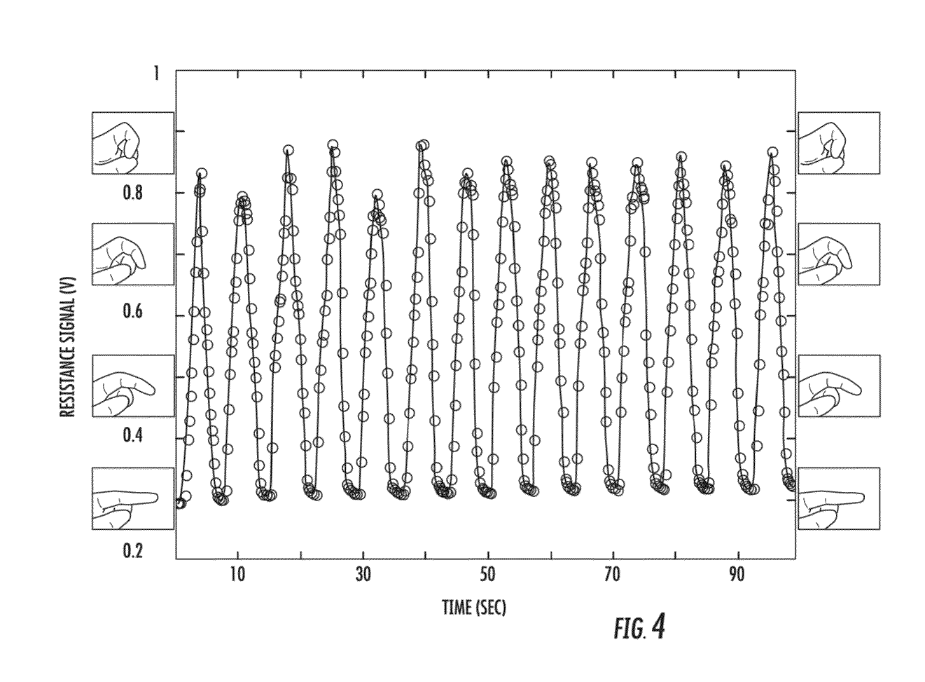

The piezoresistive sensor made in Example 1 was tested by having a person wear the piezoresistive sensor/glove and measuring the voltage changes as the wearer moved his/her finger into different positions while a 1 μA DC current was passed through the CNT/GNP hybrid thin film. Theses body movements of the wearer caused the glove (the flexible substrate) to deform and thus caused the CNT/GNP film to deform. In turn, the measured voltage changed in response to, and in a corresponding manner to, movements of the wearer's finger. The results are shown in FIG. 4.

FIG. 4 shows that when the finger gradually bent in the range of 0° to 90°, the voltage gradually increased from about 0.3 V to about 0.9 V, and that when the finger gradually bent back to 0° from 90°, the voltage gradually decreases from about 0.9 V to about 0.3 V. Theses voltage changes was reversible and nearly instantaneous.

### EXAMPLE 3

### Uses of a Wearable Piezoresistive Sensor

The wearable piezoresistive sensor made in Example 1 was adapted to produce signals which can be used to interact with other machines or devices. Specifically, the piezoresistive sensor was connected to a Keithley 2401 SourceMeter® for an I/O interface, and a LabVIEW program was used to write commands to and read signals from the SourceMeter. Through the I/O interface, the signals from the piezoresistive glove sensor were continuously transferred and stored in a personal computer. A Matlab® program was used to import, recognize, and transform the data from the human-machine interaction.

FIG. 3 shows the types of signals that were produced by having a wearer of the sensor glove bend his/her finger. Using these signal classifications, the wearable glove sensors were used to implement several man-machine interactions. In one case, the finger movement was real-time captured by monitoring the sensor's resistance change at different finger gestures. This concept could be used for human body movement monitoring/capturing and robotic movement control. In another case, the intensity of an LED light was controlled by changing finger sensor's resistance in the circuit. This concept could be used in an intelligent dimming system. In still another case, a game control, including gaming character's moving, viewing angle shifting and rifle triggering, was realized. This concept could be extended to control varied electronics or computing devices, such as picture changing/zooming, movie pausing/continuing, and AC system adjusting.

### EXAMPLE 4

### Fiber Coating Process for Use in Making a Piezoresistive Sensor

A continuous coating process was designed and used to produce a fiber having a thin film coating of CNTs and GNPs, for subsequent implementation as a piezoresistive sensor.

A computer controlled stepper motor (Silverpak 17C with PW-100-24 power supply, Lin Engineering Corps.) was setup to unwind/pull a 20 μm diameter single filament glass fiber (Fiber Glast Developments Corp., part # 223) through a series of pulley modules. The motor winding speed was set at about 1 cm/min. A spraying nozzle (adjustable nozzle set, part # AD-NOZ_{—}001, Nanotrons Corp.) was fixed to distribute a coating composition, comprising an aqueous GNP dispersion of 300 mg of graphite powder and 70 mg of SDBS in 100 g of deionized water, as a mist across the moving fiber, to form a flexible thin film coating thereon. An Iwata air compressor operated at 200 kPa was connected to the spraying nozzle to control the coating velocity. Close to the spraying nozzle, a heat gun (Master Heat Gun®, HG-301A, 260° C.) was set 20 cm away from the fiber to accelerate evaporation of the water (non-solvent for the coating composition) from the flexible thin film coating. The coated fiber was then passed through a bath with deionized water to remove the residual SDBS. After the coating process, the thin film coated fiber was dried in air at ambient temperature to obtain a conductive fiber for use in a piezoresistive sensor.

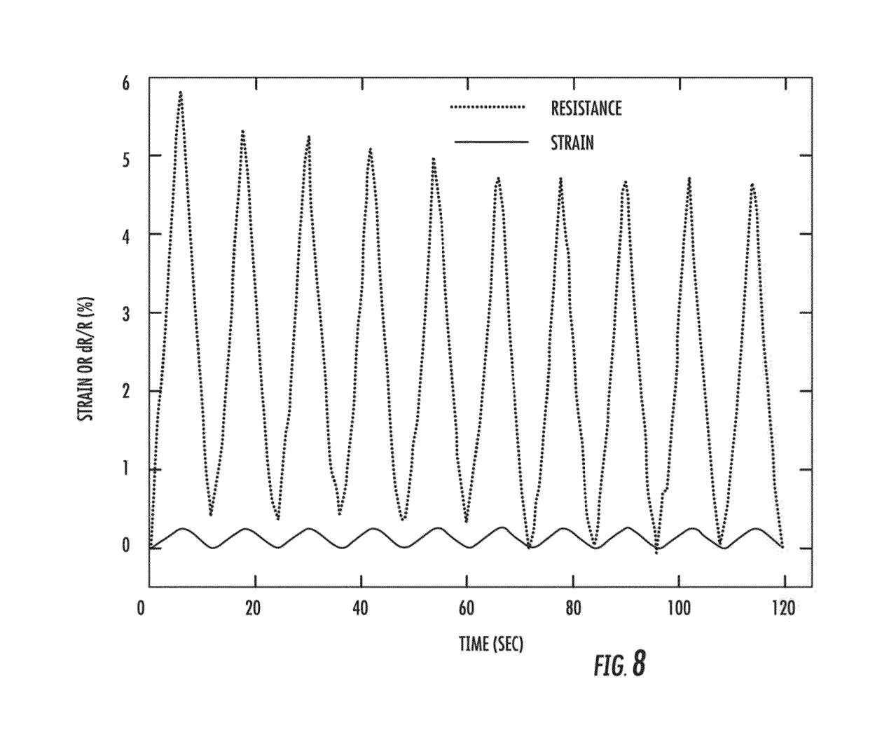

The glass fiber substrate without a coating layer is shown in FIG. 7A. Its smooth surface is evident. FIGS. 7B-7C show the fiber after it has been coated as described above. These figures show the formation of a dense layer of GNP, a thin film, coated on the glass fiber surface. FIG. 7B shows an undulated GNP coating, and FIG. 7C shows how GNP platelets are closely packed into a stacked mosaic structure. While not being limited to any particular theory, it is believed that deformation of the underlying substrate (glass fiber or other flexible substrate) causes these platelets (and/or nanotubes) to move with respect to one another, thereby altering the electrical conductive path through the mosaic structure and thus altering the measured voltage through the film.

### EXAMPLE 5

### Performance of a Fiber-Form Piezoresistive Sensor

The coated fiber made in Example 4 was tested for its suitability as a piezoresistive sensor by applying a tensile strain to the fiber and measuring its electrical resistance. A dynamic mechanical analyzer was used to apply a cyclic tensile strain to the coated fiber, in a strain range between 0 to 0.3%. As indicated by FIG. 8, a very good linear piezoresistive response was observed. That is, the resistance of the piezoresistive sensor linearly increased with increasing applied tensile strain.

According to the results of the coupled electrical-cyclic tensile test in FIG. 8, the GF of the exemplary piezoresistive sensor was evaluated according to:

$$GF = \frac{d ( Δ R / {R}_{0} )}{d ɛ} = \frac{d [ ( R ( ɛ ) - {R}_{0} ) / {R}_{0} ) ]}{d ɛ} = \frac{1}{{R}_{0}} \frac{d R}{d ɛ}$$

where ε is the mechanical strain applied to the sensor; R₀ and R are, respectively, the resistance of the sensor before and after deformation, the GF of the sensor was evaluated to be 17.0±1.3, which is comparable to the GF of a GNP thin film coated on a 2D substrate, e.g. PET.

It should be apparent that the foregoing relates only to certain embodiments of the present disclosure and that numerous changes and modifications may be made herein without departing from the spirit and the scope of the disclosure as defined by the following claims and equivalents thereof.

We claim:

1. A piezoresistive sensor comprising:
a flexible substrate;
a flexible thin film coating on the flexible substrate, wherein the coating comprises carbon nanotubes, graphite nanoplatelets, or a combination of carbon nanotubes and graphite nanoplatelets; and
two or more electrodes connected to the thin film coating at spaced locations of the thin film coating.

2. The sensor of claim 1, wherein the thin film coating is a hybrid thin film comprising carbon nanotubes and graphite nanoplatelets.

3. The sensor of claim 1, wherein the flexible substrate is in a form configured to provide conformal contact with a wearer of the sensor, so that body movements of the wearer at or about the flexible substrate effect reversible changes in a piezoresistive signal through the two or more electrodes.

4. The sensor of claim 1, wherein the flexible substrate comprises an elastomer.

5. The sensor of claim 1, wherein the flexible substrate is in the form of a sheet.

6. The sensor of claim 1, wherein the flexible substrate comprises a fiber.

7. The sensor of claim 6, wherein the fiber is selected from the group consisting of glasses, aramids, and natural fibers.

8. The sensor of claim 6, wherein the sensor comprises a plurality of coated fibers, in a bundled, networked, woven, or non-woven form.

9. The sensor of claim 1, wherein the flexible substrate is attached to or integral with a glove, sock, mask, or other article of clothing.

10. The sensor of claim 1, further comprising a power source and other electrical components for communicating with a remote device.

11. A method for a user to interact with a remote device, comprising:
providing the user with at least one of the piezoresistive sensors of claim 1, and
transmitting to the remote device a signal produced with the at least one sensor.

12. The method of claim 11, wherein the thin film coating of the sensor is a hybrid thin film comprising carbon nanotubes and graphite nanoplatelets.

13. The method of claim 11, wherein the user wears the sensor with the flexible substrate being in conformal contact with the user, so that body movements of the user at or about the thin film coating effect reversible changes in a piezoresistive signal through the two or more electrodes.

14. The method of claim 13, wherein the flexible substrate is attached to or integral with a glove, sock, mask, or other article of clothing.

15. A method for making conductive coated fibers for use in piezoresistive sensors, the method comprising:
unspooling a continuous strand of a fiber from a first roll of the fiber;
spray coating onto the continuous strand of fiber a suspension which comprises carbon nanotubes, graphite nanoplatelets, or a combination of carbon nanotubes and graphite nanoplatelets, in a liquid non-solvent;
removing the non-solvent from the continuous strand to form a flexible thin film coating on the strand of fiber, wherein the coating comprises carbon nanotubes, graphite nanoplatelets, or a combination of carbon nanotubes and graphite nanoplatelets; and
spooling the coated continuous strand onto a second roll.

16. The method of claim 15, wherein the suspension further comprises a surfactant, and the method further comprises washing the coated continuous strand to remove the surfactant from the coating before spooling the coated continuous strand on the second roll.

17. The method of claim 15, wherein the spray coating is performed in conjunction with application of heated air to accelerate evaporation of the liquid non-solvent.

18. The method of claim 15, wherein the thin film coating is a hybrid thin film comprising carbon nanotubes and graphite nanoplatelets.

19. The method of claim 15, wherein the fiber is selected from the group consisting of glasses, aramids, and natural fibers.

20. The method of claim 15, wherein the flexible thin film coating on the strand of fiber has a thickness from about 50 nanometers to about 500 nanometers.
